(19) United States
(12) Patent Application Publication
(10) Pub. No.: US 2008/0172649 A1
(43) Pub. Date: Jul. 17, 2008

(54) Strategies for Synchronizing a Product

(75) Inventors: Robert P Bisso, Saint James, NY (US); Alexander Taskov, Smithtown, NY (US); Nicholas P. Gianakas, Bayport, NY (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/623,558

(22) Filed: Jan. 16, 2007

(51) Int. Cl. G06F 9/44

(52) U.S. Cl. 717/121

(57) ABSTRACT

A strategy is described for synchronizing components of a product with respect to a reference. The strategy first supplies a manifest associated with a current version of the product. The manifest identifies the components within the product and unique identifiers associated with the components. A recipient system can compare the manifest with a locally-maintained version of the product, thereby identifying a manner in which the locally-maintained version should be modified. The recipient system can then selectively download the components that need to be added or changed. Alternatively, the recipient system can download an entire collection of components associated with the product if this is determined to be more efficient.

### BACKGROUND

Organizations commonly employ a data processing system that makes use of software products or other data provided by a number of different commercial vendors or other sources. Each vendor may modify its product over time, producing successive versions of the product. In one technique, a vendor may supply a modified product to appropriately-licensed organizations by electronically downloading a complete collection of files associated with the product to the organizations.

As appreciated by the present inventors, there are various shortcomings with known approaches to modifying products. For instance, a typical product may have a relatively large size. The task of downloading such a product may therefore require a significant amount of time and may make significant demands on the resources of an organization. This problem is compounded when an organization must maintain current versions of multiple different products. An organization may address this problem by adding additional bandwidth, yet this may be a relatively costly solution. Furthermore this solution does not scale well to the evolving needs of the organization.

### SUMMARY

A strategy is described for modifying one or more products. A product may pertain to any information produced for any purpose by any source or combination of sources. In one exemplary and non-limiting implementation, a product may comprise any kind of security-related engine. The security-related engine may comprise an anti-virus engine, anti-spam engine, anti-spyware engine, and so forth. Each engine, in turn, may include multiple components, such as multiple files.

The strategy modifies a product using a synchronization approach. According to one implementation, the strategy relies on a backend system to receive information regarding a current version of at least one product. The backend system generates a manifest for the product. The manifest identifies a list of components in the product as well as a unique identifier reflecting the contents of each component associated with the product. The unique identifier can comprise, but is not limited to, a cryptographic signature of the contents of a component. The backend system then posts the current version of the product along with the manifest to a distribution system.

A recipient system associated with an organization can receive the manifest from the distribution system. Upon receipt, the recipient system compares the unique identifiers in the manifest with unique identifiers associated with an existing locally-maintained version of the product. Through this comparison, the recipient system can identify one or more components of the local version of the product that require changing. The recipient system can also identify components that are specified in the manifest but are absent in the locally-maintained version of the product, and vice versa. The recipient system can then selectively receive current versions of just the components of the product that need to be added or changed. The recipient system modifies the local version of the product based on the received components. The recipient system can also delete components in the product that do not have counterpart components specified in the manifest. Through these changes, the locally-maintained version of the product is synchronized with the version identified in the manifest. As an end result, the locally-maintained version is made to “mirror” the version identified in the manifest.

According to another exemplary feature, the strategy can optionally determine whether it is more appropriate to selectively download individual components of the product or the entire product. To make this decision, the strategy can rely on one or more factors, such as the relative number of components that need to be sent, the relative aggregate size of the components that need to be sent, and various timing calculations that more directly estimate the tradeoff between downloading individual components as opposed to the entire package.

The strategy confers a number of benefits. According to one exemplary benefit, the recipient system can modify one or more products in a more time-efficient and bandwidth-efficient manner than known approaches (which involve indiscriminately downloading an entire version of each product).

Additional exemplary implementations and attendant benefits are described in the following.

### BRIEF DESCRIPTION OF THE DRAWINGS

FIG. 1 shows an exemplary system for modifying one or more products, including a backend system, a distribution system, and at least one recipient system.

FIG. 2 shows exemplary processing functionality for implementing any aspect of the system of FIG. 1.

FIG. 3 shows an exemplary procedure that explains one manner of operation of the backend system used in the system of FIG. 1.

FIG. 4 shows an exemplary procedure that explains one manner of operation of the distribution system used in the system of FIG. 1.

FIGS. 5 and 6 show exemplary procedures that together explain one manner of operation of a recipient system used in the system of FIG. 1.

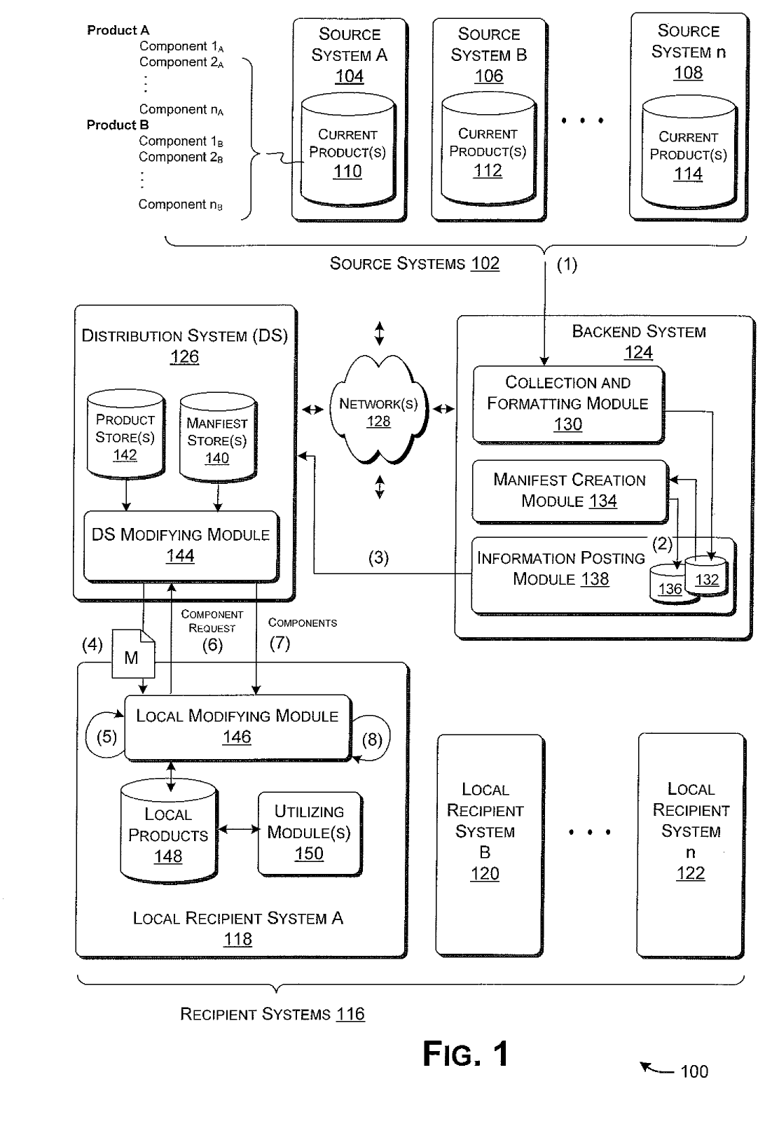

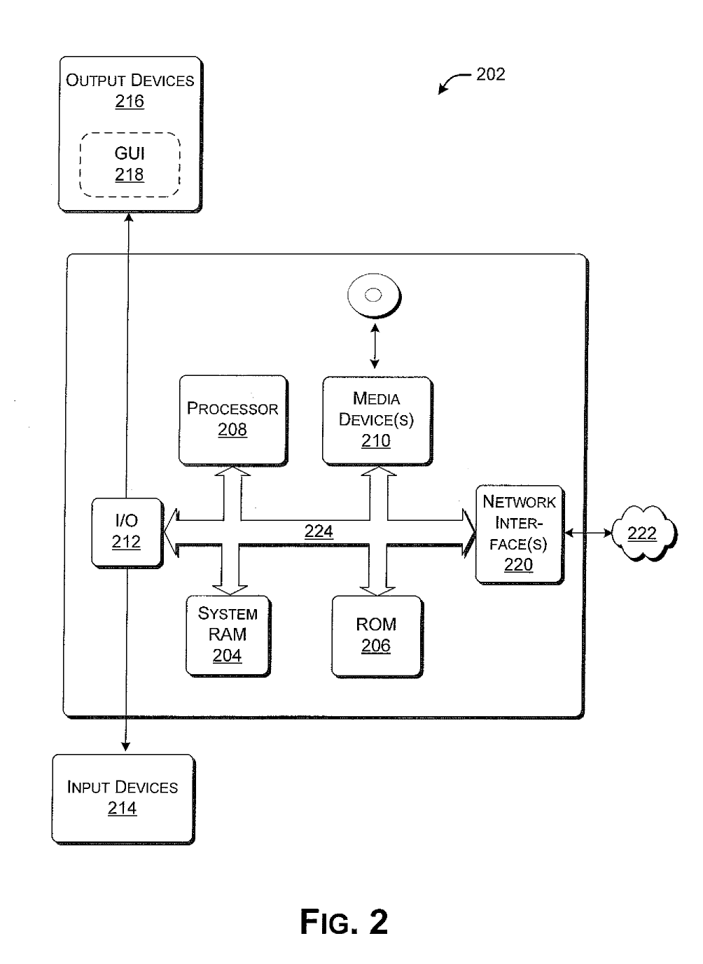

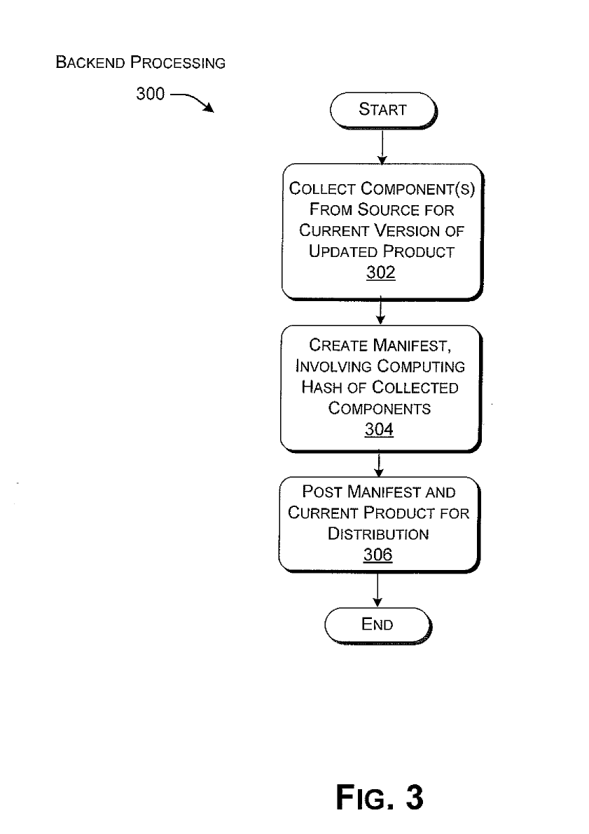

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure sets forth a strategy for modifying products that include components. The strategy can be manifested in various systems, apparatuses, modules, procedures, storage mediums, data structures, and other forms.

This disclosure includes the following sections. Section A describes an exemplary system for modifying products. Section B describes exemplary procedures that explain the operation of the system of Section A.

A. Exemplary System

As a preliminary note, any of the functions described with reference to the figures can be implemented using software, firmware, hardware (e.g., fixed logic circuitry), manual processing, or a combination of these implementations. The term “logic, “module,” “component,” “system” or “functionality” as used herein generally represents software, firmware, hardware, or a combination of the elements, For instance, in the case of a software implementation, the term “logic,” “module,” “component,” “system,” or “functionality” represents program code that performs specified tasks when executed on a processing device or devices (e.g., CPU or CPUs). The program code can be stored in one or more computer readable memory devices.

More generally, the illustrated separation of logic, modules, components, systems, and functionality into distinct units may reflect an actual physical grouping and allocation of software, firmware, and/or hardware, or can correspond to a conceptual allocation of different tasks performed by a single software program, firmware program, and/or hardware unit. The illustrated logic, modules, components, systems, and functionality can be located at a single site (e.g., as implemented by a processing device), or can be distributed over plural locations.

The terms “machine-readable media” or the like refers to any kind of medium for retaining information in any form, including various kinds of storage devices (magnetic, optical, static, etc.). The term machine-readable media also encompasses transitory forms for representing information, including various hardwired and/or wireless links for transmitting the information from one point to another.

A.1. Exemplary System for Synchronizing Files

FIG. 1 shows one exemplary system 100 for modifying one or more products, where the products are made up of components. The term “products” should be liberally construed as used herein. Generally, a product refers to any information produced for any purpose. In one case, the product may perform a function when executed by a processing device. For example, the product can correspond to any kind of security-related engine or any combination of different kinds of security-related engines. Exemplary types of security-related engines include anti-virus engines (designed to address the threat of computer viruses), anti-spam engines (designed to address the threat of unsolicited electronic messages), anti-spyware engines (designed to address the threat of unauthorized monitoring software), and so on. The system 100 can also be used to modify any other type of product that performs a function, including products that do not perform a security-related function. In another case, the term product may refer to data that does not necessarily perform a function. For example, the product can correspond to a collection of image or video files, audio files, text files, and so forth.

The term “component” refers to a part of a product. In one case, a product's components may comprise a collection of files, including, but not limited to, one or more executable binary files, one or more non-executable files, and so on. As used herein, a “package” refers to a collection of components associated with a product.

In one case, a product may include components which have a thematic relation to a single identified subject. For example, a product's components can correspond to a complete suite of files that make up the engine and enable it to perform its ascribed functions. In other cases, a product may more loosely refer to any aggregate of components that are not necessarily related to a single parent theme. For example, a product may correspond to a collection of files that are associated with different engines. Indeed, a “product” may be associated with a directory that identifies multiple products and/or other data. In this context, the strategy described herein can also be used to synchronize any part of a local directory with a target source directory.

The term “modifying,” as in the context of “modifying a product,” refers to any changes made to a local instance of the product to synchronize the product with an identified target instance of the product. Modifying may involve adding components to the local instance of the product that are currently absent, removing components of the local instance of the product, and/or modifying the contents of existing components of the local instance of the product. In a special case, modifying can entail creating an entirely new local instance of the product, there being no preexisting local instance of the product. A “version” of a product refers to an instance (e.g., a manifestation) of the product.

As shown in FIG. 1, the system 100 includes a collection of source systems 102, including exemplary source systems 104, 106, 108, etc. The source systems 102 correspond to any entities which produce or otherwise provide products (as broadly described above). The different source systems 102 may correspond to vendors of different types of software products. For example, system 104 may correspond to a company A which produces one or more anti-virus engines. System 106 may correspond to a company B which produces one or more anti-spam engines, and so on. Alternatively, or in addition, one or more sources 102 may refer to entities within an organization that produce products for use by the organization.

In a typical development cycle, a source system will produce an original version of its product and then successively release a series of modified versions over time. At any given time, the source system may store current versions of its products for distribution to customers. For example, source system 104 includes a store 110 that stores current versions of one or more products for distribution, source system 106 includes a store 112 that stores current versions of one or more products for distribution, and source system 108 includes a store 114 that stores current versions of one or more products for distribution. For example, as generically illustrated in FIG. 1, store 110 includes a current version of Product A (comprising component files 1_{A}-n_{A}, a current version of Product B (comprising component files 1_{B}-n_{B}), and so on.

The system 100 also includes one or more recipient systems 116. The recipient systems 116 comprise various data processing systems that utilize the products produced by the source systems 102. For example, exemplary recipient system 118 may comprise a data processing system used by any type of organization, such as a company, a governmental entity, an academic institution, and so on. The data processing system may perform various functions, such as, in part, allowing members of the organization to send and receive electronic messages. In this scenario, the recipient system 118 may use one or more security-related engines provided by the source systems 102 to help prevent disruption of its message-sending functionality. Exemplary recipient systems 120 and 122 can use different collections of products to provide other types of functions.

In general, the versions of the products used by the recipient systems 116 comprise so-called “local” versions of the products. The recipient systems 116 may store these local versions of the products in one or more local stores.

By way of overview, the purpose of the system 100 is to collect information regarding the current versions of products provided by the source systems 102. The system 100 then synchronizes the local versions of the products used by the recipient systems 116 so that the local versions are the same as the corresponding current versions. This synchronizing operation can be performed on a per-component basis, that is, by identifying components of the local versions that need to be changed (e.g., modified, added, or deleted), and then carrying out these changes on a component-by-component basis. In other cases, the system 100 can determine that it is more efficient for the recipient systems 116 to receive complete copies of the current versions of the products, rather than affecting change on a component-by-component basis.

To perform the above-described functions, the system 100 can rely on a backend system 124 and a distribution system 126. These systems (124, 126) are described in detail below. The backend system 124 and distribution system 126 can be provided at the same location or different respective locations. These two systems (124, 126) can be administered by the same entity or different respective entities. One or more networks 128 can communicatively couple all of the parts of the system 100 together.

The backend system 124 (also referred to as a manifest-generating system herein) includes various parts. As a first part, the backend system 124 includes a collection module 130. The purpose of the collection module 130 is to collect information regarding the current versions of the products from the source systems 102. The collection module 130 can perform this task in different ways. According to one case, the collection module 130 can actively poll the different source systems 102, inquiring whether any of the source systems 102 have stored new versions of products (since the last time the source systems 102 were polled). According to the terminology used herein, these new versions constitute “current versions.” In response to this polling, the source systems 102 can forward any current versions of the products to the collection module 130 (e.g., via the network 128). More specifically, the source systems 102 can transmit entire packages corresponding to the current versions or just selected parts of the products. In another case, the source systems 102 can proactively transmit current versions of the products to the collection module 130 (e.g., without being polled by the collection module 130). In either case, in response to receiving the current versions of the products, the collection module 130 can store these products in one or more stores 132. The collection module 130 can also optionally reformat the received products to express the products in a uniform or otherwise preferred format.

The backend system 124 also includes a manifest creation module 134. The purpose of the manifest creation module 130 is to create a manifest for each product that is received from the source systems 102. A manifest is a collection of information which describes the makeup of a product. Subsection A.2 (below) provides detailed information regarding one exemplary composition of a manifest.

By way of overview, the manifest can identify the different components (e.g., files) within a product. The manifest can also store unique identifiers associated with each of the product's components. In one implementation, the manifest creation module 130 can generate cryptographic signatures by hashing the contents of the files associated with the product, wherein the signatures constitute the unique identifiers. That is, the manifest creation module 130 can generate a signature S_{1A} by subjecting the content of file 1_{A} to a hash algorithm, a signature S_{2A} by subjecting the content of file 2_{A} to the hash algorithm, and so on. The manifest creation module 134 can use any type of hash algorithm to perform this operation, such as, without limitation, the well-known SHA1 hashing algorithm. The hash of a file acts as a unique “fingerprint” of the file. Thus, if any part of the content of the file changes, its hash will likewise change. The manifest can also include other fields of information, such as a time-to-live (TTL) indicator. The TTL indicator identifies a length of time for which the manifest is to be considered valid.

The manifest creation module 130 can generate a digital signature of the manifest and apply the signature to the manifest. The digital signature can be used to validate that the manifest file has not been tampered with. The manifest creation module 130 can store the manifest it creates in one or more stores 136.

Finally, the backend system 124 can include an information posting module 138. The purpose of the information posting module 138 is to transfer the current versions of the products (in stores 132) and the manifests (in stores 136) to the distribution system 126. The information posting module 138 can carry out this transfer by sending the information over the networks 128.

The purpose of the distribution system 126 is to distribute the manifests and current versions of the products to the various recipient systems 116. To this end, the distribution system 126 can include one or more stores 140 for storing the manifests and one or more stores 142 for storing the current versions of the products. The distribution system 126 can also include a distribution system (DS) modifying module 144 for interacting with the recipient systems 116 (via the networks 128) to accomplish the transfer of manifests and product components.

Now turning to the recipient systems 116, FIG. 1 shows the exemplary composition of one recipient system—namely, recipient system 118. As described above, the recipient system 118 can comprise a data processing system employed by an organization (or other type of entity) to perform any type of function. Broadly illustrated, the recipient system 118 includes a local modifying module 146. The purpose of the local modifying module 146 is to interact with the DS modifying module 144 of the distribution system 126 to modify the local version of the recipient system's products. One or more stores 148 can store the local version of the products and associated manifests. One or more utilizing modules 150 can rely on the local versions of the products in performing functions. For example, one utilizing module 150 may comprise an Email system for sending and receiving Email messages. This type of module 150 can rely on a collection of security-related engines (anti-virus engines, anti-spam engines, anti-spyware engines, etc.) to perform its tasks, where each engine may comprise a collection of components (e.g., files). It should be noted that the stores 148 and utilizing modules 150 represent a very high-level depiction of the recipient system's architecture. In actual practice, a modifying operation may involve storing new components at several different locations within the recipient system 118 or may involve storing the new components at a central location, where the components are accessible to any part of the recipient system 118.

The local modifying module 146 in conjunction with the DS modifying module 144 can modify products on a component-by-component basis using the manifest, rather than requiring the recipient system 118 to always receive complete copies of current versions of the products. This operation will be described with respect to the modifying of a single product, keeping in mind that the same operation can be repeated for any number of products.

First, the local modifying module 146 receives a manifest for a particular product that has been newly modified. This manifest-transferring operation can be triggered by various events. In one case, the local modifying module 146 can periodically poll the distribution system 126 to first ensure that the digital signature associated with the manifest has not been tampered with since creation. The local modifying module 146 can then examine the manifest to determine whether it identifies a new version of a product used by the recipient system 118. If so, the DS modifying module 144 can transfer the manifest to the local modifying module 146 via the networks 128. More specifically, the local modifying module 146 can potentially poll the distribution system 126 according to different schedules for different respective products used by the recipient system 118. This provision allows the local modifying module 146 to set the polling frequencies for different products based on how quickly the products are expected to change. In another case, the distribution system 126 can proactively transfer the manifest of a newly modified product to the recipient system 118 (that is, without being polled by the recipient system 118). The distribution system 126 can perform this transfer when it receives new information from the backend system 124, or in response to some other triggering event. The manifest that is downloaded to the recipient system 118 can be optionally compressed to expedite transfer.

When the local modifying module 146 receives the manifest, it can first examine the TTL indicator in the manifest to determine whether the manifest is valid. For example, the TTL indicator may indicate the manifest is valid for five days after a creation date (which is also identified by the manifest). If the local modifying module 146 determines that the manifest has been received outside the window of time identified by the TTL indicator, it can reject the manifest. This validation operation reduces the chances that recipient system 118 will act on an unauthorized manifest (which may have been transmitted by a malicious entity).

After ensuring that the manifest has been timely received, the local modifying module 146 can use the manifest to determine what parts of the local version of the product require changing. Modifications can take the form of at least three types of changes. In a first case, the local modifying module 146 can determine that the contents of one or more components of the local version have changed relative to counterpart components in the current version. In a second case, the local modifying module 146 can determine that the local version of the product includes one or more components that are no longer being used in the current version of the product. In a third case, the local modifying module 146 can determine that one or more components identified in the current version of the product are completely missing from the local version of the product.

As to the first type of change, the local modifying module 146 can determine whether or not a component in the current version of the product has been modified relative to a counterpart component in the local version by comparing a unique identifier specified in the manifest with a unique identifier associated with the local version component. Consider the example in which the unique identifier corresponds to a hash of the component's content. In this case, the local modifying module 146 can first compute a hash of the local component. The local modifying module 142 then compares the hash specified in the manifest with the computed hash of the local component. If these two hashes differ this means that a change has been made to the current component relative to the local component. The change can have any scope—it potentially may be a very small change (e.g., one bit or character may be different) or a very large change.

The local modifying module 146 can record the changes that it detects in one or more lists. A first list can identify components in the local version that have content-modified counterpart components in the current version. A second list can identify components in the local version that are no longer being used in the current version. A third list can identify components in the current version that have no existing counterparts in the local version. The local modifying module 146 can then send a request to the DS modifying module 144, asking the distribution system 126 to forward just the identified components in the above-identified first and third lists, omitting the remainder of the other components that do need to be acted on. The DS modifying module 144 responds to this request by selectively sending the recipient system 118 the requested components. As can be appreciated, this selective transfer of information can allow the distribution system 126 to more quickly modify the recipient system 118 because it is freed from the burden of having to send the complete package of components that make up the product. The components that are downloaded to the recipient system 118 can be optionally compressed to expedite transfer. The recipient system 118 can also remove the components in the local version of the product (identified in the second list) that are not identified in the manifest.

Consider the following example. A hypothetical product includes four versions, including the exemplary component parts identified by the following table:

| Version 1 Files | Version 2 Files | Version 3 Files | Version 4 Files |
|---|---|---|---|
| A1 | A2 | A2 | A2 |
| B1 | B2 | B3 | B4 |
| C1 | C1 | C3 | C3 |
| D1 | D1 | D1 | D1 |

The most current version is Version 4. If the local recipient system 118 includes Version 1 of the product in its local store 148, then the system 100 will download components A2, B4, and C3. If the local recipient system 118 includes Version 2 of the product it its local store 148, then the system 100 will download components B4 and C3. If the local recipient system 118 includes Version 3 of the product it its local store 148, then the system 100 will download just the B4 component. Based on this example, note that there is no requirement that the recipient system 118 make changes based on an immediately prior version. That is, for example, the recipient system 118 can synchronize to Version 4 of the product based on Version 1 or Version 2 of the product in its local store 148.

In some cases, the system 100 can determine that it is more efficient to transfer the entire package of the product being modified. This may be because it may take longer to individually transfer the components that have changed as opposed to sending the entire package. Various factors may play a part in making this decision. One such factor is the number of components that need to be sent relative to the total number of components in the package. Another factor is the aggregate size of the components that need to be sent relative to the total size of the package. Other factors more directly take into account the amount of time that it is estimated to take to transfer individual components as opposed to the entire package.

More specifically, according to one exemplary and non-limiting case, the system 100 can decide to send the entire package (rather than individual components that need to be sent) if the percentage of components that need to be sent (relative to the total number of components in the package) exceeds a prescribed threshold, such as, without limitation, 80 percent. In another case, the system 100 can decide to send the entire package if the aggregate size of the components that need to be sent (relative to the total size of the package) exceeds a prescribed threshold, such as, without limitation, 70 percent. In another case, the system 100 can determine to send the entire package only if both the above-described number-based and size-based thresholds are satisfied.

In another case, the system 100 can perform more complex calculations that more directly estimate the amount of time required to transmit individual components as opposed to the entire package. In one implementation, the time (t_{inc}) required to transmit n number of individual components and the time (tₜₒₜ) required to transmit the total package can be respectively approximated by:

$${t}_{inc} = n \times H + \frac{{S}_{inc}}{v}$$

$${t}_{tot} = H + \frac{{S}_{tot}}{v}$$

where:
t_{inc} is the time to transmit the components that need to be sent;
tₜₒₜ is the time to transmit the entire package;
n is the number of components that need to be sent (out of N total components in the package);
H is the handshake overhead involved in the transfer;
S_{inc} is the aggregate size of the components that need to be sent;
Sₜₒₜ is the total size of the package; and
v is the rate at which information can be transmitted

It is more efficient to transmit individual files as long as t_{inc}<tₜₒₜ. This relationship can be expressed by the following equation:

$$n < \frac{{S}_{tot} + v \times H}{v \times H + \frac{{S}_{tot}}{N}} .$$

The logic that makes the decision as to whether to transfer the components in piecemeal or package-based fashion can be located at different parts of the system 100. In one case, the local modifying module 146 of the recipient system 118 can make this determination. In this case, the recipient system 118 can convey the results of its decision to the distribution system 126. That is, based on its decision, the recipient system 118 can send a request for individual components or a request for the entire package of components. In another case, the DS modifying module 144 of the distribution system 126 can make the decision as to whether to send individual components or to send the entire package upon receiving a generic request from recipient system 118. In still another case, the decision-making responsibility can be shared by the distribution system 126 and the recipient system 118.

Upon receipt of the components to be added and/or changed, the local modifying system 146 can employ various mechanisms for modifying the local version of the product stored in stores 148. For instance, the local modifying module 146 can store the new products and/or individual components in one or more staging stores prior to their formal deployment by the recipient system 118. In one case, modifying may involve unloading an entire product or part thereof and then reloading the new product or part thereof. This may be appropriate when the binary of an executable changes. In another case, modifying may involve just resetting an existing product or part thereof. This may be appropriate when a signature of a component changes.

The system 100 repeats the above-described operations for each product (e.g., engine) that requires modifying. This implementation requires successively downloading and acting upon different manifests associated with different respective products (based on different modifying schedules associated with different respective products). In another implementation, the system 100 can prepare a master manifest that provides information pertaining to multiple different kinds of products. In this implementation, the local modifying module 146 can accomplish the modifying operation by receiving and acting on a single manifest.

The numbers in parentheses in FIG. 1 summarize certain aspects of the above-described operations. In operation (1), the backend system 124 receives information regarding current versions of products provided by the source systems 102. In operation (2), the backend system 124 generates one or more manifests associated with the current versions of the products. In operation (3), the backend system 124 posts the current versions and associated manifests to the distribution system 126. In operation (4), the recipient system 118 receives one of the manifests posted to the distribution system 126. In operation (5), the recipient system 118 uses the manifest to determine whether any of the components of the local version of the product changed, added, or deleted. In operation (6), the recipient system 118 requests the distribution system 126 to supply the components that need to be changed or added. In operation (7), the distribution system 126 supplies the requested components. In operation (8), the recipient system 118 receives the components and modifies the local version of the product using these components. Modification may also involve removing one or more existing components of the local version that are no longer being used.

A.2. Exemplary Manifest File

The following subsection identifies the composition of one exemplary manifest file. As described above, the manifest file describes salient features of the composition of one product. The product includes a plurality of components (e.g., files).

In one exemplary case, the manifest can be expressed in the extensible markup language (XML). The manifest can include various nodes and associated parameters, as described below.

ManifestFile Node

The Manifest node describes high-level information regarding the manifest. It may include the following parameters.

Created. This parameter identifies the date and time that the package was created.

Version. This parameter identifies a version of the manifest file. This parameter is used in case the format changes so it is possible to differentiate between different XML formats

Package Node

The Package node describes high-level information regarding the product that is described by the manifest.

Type. This parameter identifies the type of product being described by the manifest. For instance, this parameter may identify the product as an engine package.

Name. This parameter identifies the name of the product.

Platform. This parameter indicates the architecture that the binaries of the product run on (e.g., x86, amd64, ia64, etc.).

Version. This parameter indicates a version of the product-modifying logic used by the system 100. This version parameter can be unique to each source system 102.

Updatemode. This parameter specifies a type of modification to be performed (e.g., fall, auto, incremental); “full” instructs the modification operation to obtain an entire package; “incremental” instructs the modification operation to obtain individual files; and “auto” allows the modification operation to decide between full and incremental based on efficiency considerations.

Postupdateaction. This parameter specifies a default post-modification action for the package. This parameter can be used to specify one or more actions to be performed following a successful update, such as a reloading action, a resetting action, and so forth.

TTL. This parameter specifies a number of days that the manifest file is valid, with reference to the “created” date/time.

FullPackage Node

The FullPackage node lists the attributes for the full product package. In other words, this node describe the package as an integral whole, e.g., for the purpose of transmitting the package as an integral whole.

Type. This parameter indicates the file format of the package.

Name. This parameter specifies the name of the package file.

Size. This parameter specifies the size (e.g., in bytes) of the package file.

Algorithm. This parameter specifies the cryptographic hash algorithm used to generate the hash of the package file

Hash. This parameter specifies the hash produced by the bash algorithm.

Files Node

The File node identifies the individual components that comprise the package. In other words, each component in the package is described using the following set of parameters.

Name. This parameter specifies the name of the component.

Path. This parameter identifies whether the component belongs in a subdirectory under an identified destination path.

Datetime. This parameter specifies a date/time stamp associated with the component.

Size. This parameter specifies the uncompressed size of the component.

Csize. This parameter specifies the compressed size of the component.

Postupdateaction. This parameter identifies the component modification action to be performed upon receipt of the component (e.g., reset, reload, etc.).

zipOrder. This parameter is used to indicate an index of the component if the component is placed in a larger container/package (such as a zip file). This parameter allows the hash from the backend system 124 and the hash from the local system 118 to match.

Algorithm. This parameter specifies the cryptographic hash algorithm used to compute the hash for the component.

Hash. This parameter specifies the hash of the component.

CHash. This parameter specifies the hash value of the compressed component.

A.3. Exemplary Processing Functionality

FIG. 2 sets forth exemplary processing functionality 202 that can be used to implement any aspect of system 100 shown in FIG. 1. In one non-limiting case, for instance, the processing functionality 202 may represent any computer machine used by the system 100, e.g., in any of the source systems 102, the backend system 124, the distribution system 126, any of the recipient systems 116, and so on. The processing functionality 202 can include various volatile and non-volatile memory, such as RAM 204 and ROM 206, as well as one or more central processing units (CPUs) 208. The processing functionality 202 can perform various operations identified above when the CPU 208 executes instructions that are maintained by memory (e.g., 204, 206, or elsewhere). The processing functionality 202 also optionally includes various media devices 210, such as a hard disk module, an optical disk module, and so forth.

The processing functionality 202 also includes an input/output module 212 for receiving various inputs from the user (via input devices 214), and for providing various outputs to the user (via output devices 216). One particular output device may include a display apparatus and an associated graphical user interface (GUI) 218. The processing functionality 202 can also include one or more network interfaces 220 for exchanging data with other devices via one or more communication conduits 222. One or more communication buses 224 communicatively couple the above-described components together.

The communication conduits 222 can be implemented in different ways to suit different technical and commercial environments. For instance, the communication conduits 222 can include any kind of network (or combination of networks), such as a wide area network (e.g., the Internet), an intranet, Digital Subscriber Line (DSL) network infrastructure, point-to-point coupling infrastructure, and so on. In the case where one or more digital networks are used to exchange information, the communication conduits 222 can include various hardwired and/or wireless links, routers, gateways, name servers, and so on. The communication conduits 222 can be governed by any protocol or combination of protocols. (In the context of FIG. 1, the communication conduits 222 may represent the networks 128.)

B. Exemplary Procedure

FIGS. 3-6 show various procedures which explain the operation of the system 100 in flow chart form. To facilitate discussion, certain operations are described as constituting distinct blocks performed in a certain order. Such implementations are exemplary and non-limiting. Certain blocks described herein can be grouped together and performed in a single operation, and certain blocks can be performed in an order that differs from the order employed in the examples set forth in this disclosure. The blocks shown in the flowcharts can be implemented by software, firmware, hardware, manual processing, any combination of these implementations, and so on.

As the functions described in the flowchart have already been set forth in Section A, Section B serves principally as a review of those functions.

B.1. Backend Processing

FIG. 3 shows a procedure 300 which explains the operations of the backend system 124 of FIG. 1, in the context of the generation of a single manifest.

In operation 302, the backend system 124 collects information regarding a current version of a product from one of the source systems 102. For instance, as described above, in one case the backend system 124 can periodically poll an appropriate source system to collect modified information regarding the product (if it is determined that the product has changed since the last polling event).

In operation 304, the backend system 124 creates a manifest for the current version of the product. One exemplary manifest was described in detail above in Subsection A.2. The manifest can identify the components (e.g., files) in the product and the hash values associated with the components. The manifest can also include a time-to-live (TTL) indicator which identifies a period of time for which the manifest will be assumed to be valid.

In operation 306, the backend system 124 posts the manifest and current version of the product to the distribution system 126.

B.2. Distribution System Processing

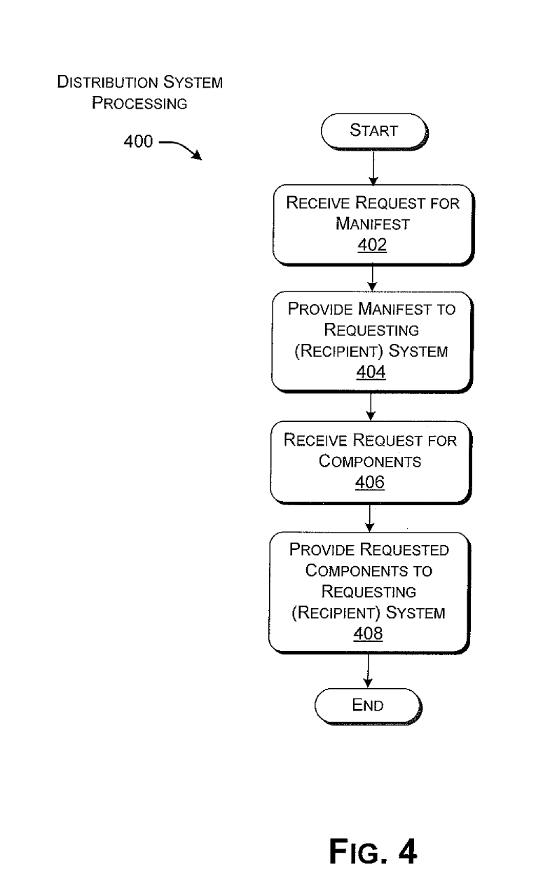

FIG. 4 shows a procedure 400 which explains the operation of the distribution system 126 of FIG. 1.

In operation 402, the distribution system 126 receives a request for a manifest from the recipient system 118. The recipient system 118 may periodically make such a request to determine whether any new manifests have been received. Alternatively, the distribution system 126 can proactively send a newly-received manifest to the recipient system 118 without being polled by the recipient system 118.

In operation 404, the distribution system 126 forwards the requested manifest to the recipient system 118. The recipient system 118 uses the manifest to determine which components of the local version of the product require modifying,

In operation 406, the distribution system 126 receives a request from the recipient system 118 for components of the local version of the system that need to be added or changed.

In operation 408, the distribution system 126 supplies the requested components to the recipient system 118. The distribution system 126 may perform this task by selectively sending only the requested components. Alternatively, if it is determined to be more efficient, the distribution system 126 can send the entire package associated with the product being modified.

B.3. Recipient System Processing

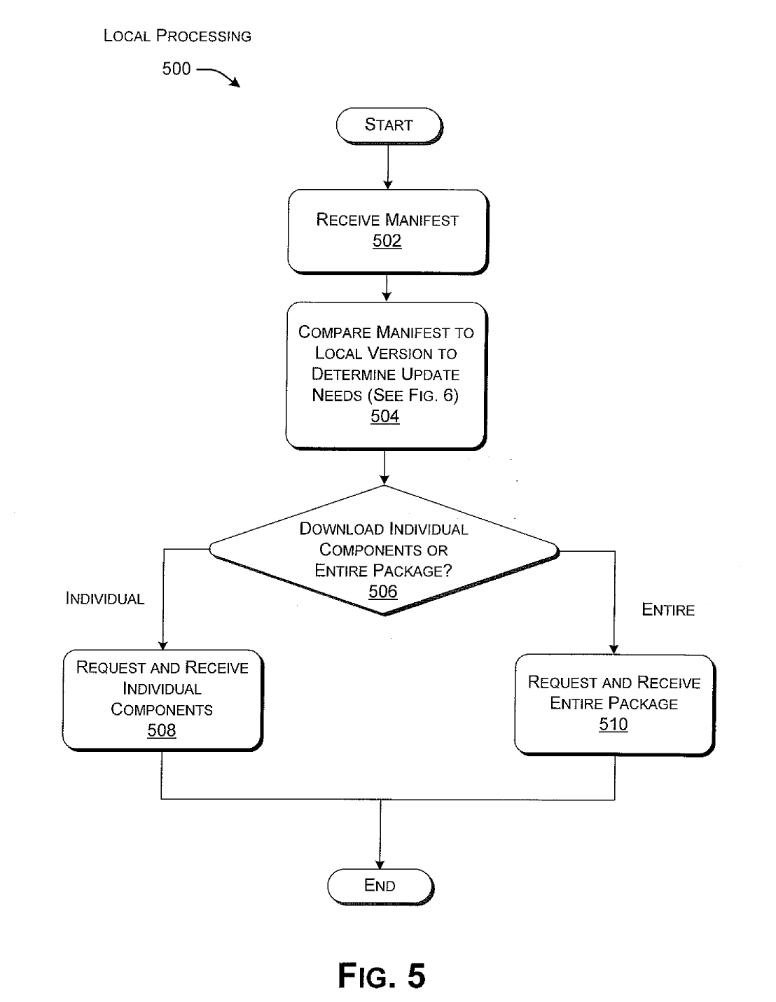

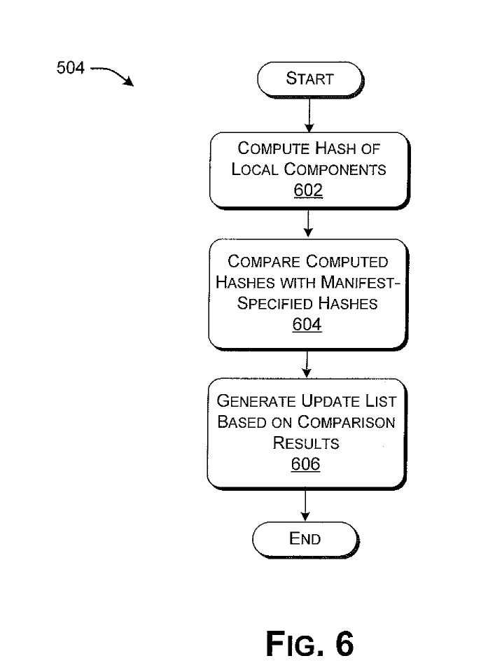

FIGS. 5 and 6 collectively show a procedure 500 used by the local recipient system 118 of FIG. 1 to modify a local version of the product based on the received manifest.

In operation 502, the recipient system 118 receives the manifest from the distribution system 126.

In operation 504, the recipient system 504 compares the manifest to the local version of the product to determine which components of the local version need to be acted on. The result of this operation can identify components of the local version that have changed in content (relative to the current version), components of the local version that are no longer being used in the current version, and components of the current version that have no corresponding components in the local version.

In operation 506, the recipient system 118 can determine whether it is more efficient to selectively download only the components that need to be added and changed, as opposed to downloading the entire package of components. As described above, the recipient system 118 can rely on various factors in making this decision, such as the relative number of components to be sent, the relative aggregate size of the components to be sent, direct estimates of the amount of time required to selectively download the individual components as opposed to the entire package, and so on. FIG. 5 indicates that the recipient system 118 is the agent which makes the piecemeal-versus-entire determination, but, as stated above, the distribution system 126 can also make these determinations (in whole or in part).

In operation 508, the recipient system 118 requests and receives the components to be added or changed on a piecemeal basis.

In operation 510, the recipient system 118 alternatively requests and receives the components to be added or changed as an entire package.

FIG. 6 shows a procedure which elaborates on operation 504. In this procedure, the recipient system 118 determines which components of the local version of the product have changed.

In operation 602, the recipient system 118 computes hashes for all of the components of the local version of the product.

In operation 604, the recipient system 118 compares the computed hashes to the hashes identified in the manifest. Discrepancies between the computed and manifest-specified hashes identify components that have changed.

In operation 606, the recipient system 118 generates a list which identifies those components of the local version of the product that have changed, and therefore require modifying. The recipient system 118 can generate other lists which identify components to be entirely deleted from the local version and entirely new components to be added to the local version.

In closing, a number of features were described herein by first identifying exemplary problems that these features can address. This manner of explication does not constitute an admission that others have appreciated and/or articulated the problems in the manner specified herein. Appreciation and articulation of the problems present in the relevant art(s) is to be understood as part of the present invention.

More generally, although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A computerized method for modifying a product, comprising:
receiving a manifest, the manifest identifying a list of components of a current version of the product;
comparing the manifest against a local version of the product to identify a manner in which the local version is to be modified; and
modifying the local version of the product in the identified manner.

2. The computerized method of claim 1, wherein the product is an engine that performs a function.

3. The computerized method of claim 2, wherein the components are respective files that make up the engine.

4. The computerized method of claim 3, wherein the files comprise at least one executable file and at least one signature file.

5. The computerized method of claim 2, wherein the engine comprises a security-related engine.

6. The computerized method of claim 1, wherein the method is used to modify a plurality of products, the method comprising repeating the modifying a plurality of times based on a plurality of respective received manifests associated with the plurality of products.

7. The computerized method of claim 1, wherein the manifest comprises a plurality of current unique identifiers associated with the components of the current version of the product.

8. The computerized method of claim 7, wherein the current unique identifiers comprise cryptographic signatures of the contents of the components of the current version of the product.

9. The computerized method of claim 7, wherein the comparing comprises:
forming local unique identifiers associated with components of the local version of the product; and
comparing the current unique identifiers with the local unique identifiers to determine if there are any discrepancies.

10. The computerized method of claim 1, wherein the modifying comprises at least one of:
changing a component of the local version of the product;
adding a new component to the local version of the product; or
deleting a component of the local version of the product.

11. The computerized method of claim 1, wherein the modifying comprises selectively receiving at least one component of the current version of the product, wherein said at least one component is identified by said comparing.

12. The computerized method of claim 1, wherein the modifying comprises determining whether it is more appropriate to receive an entire collection of components associated with the current version of the product as opposed to one or more individual components of the current version of the product, and, if it is determined to be more appropriate, receiving the entire collection of components.

13. The computerized method of claim 12, wherein the determining of whether it is more appropriate to receive an entire collection of components is based on one or more of:
a relative number of components that are to be sent;
a relative aggregate amount of information associated with the number of components to be sent; or
at least one timing estimate of an amount of time needed to transfer the number of components to be sent as opposed to the entire collection of components.

14. One or more machine-readable media containing machine-readable instructions for implementing the computerized method of claim 1.

15. One or more computing devices, comprising:
one or more processors; and
memory to store computer-executable instructions that, when executed by the one or more processors, perform the computerized method of claim 1.

16. A computerized method for generating a manifest, a current version of a product being synchronized with a local version of the product based on the manifest, the method comprising:
receiving information regarding the current version of the product from a source of the current version of the product;
forming unique identifiers of components within the current version of the product;
generating a manifest which identifies:
a list of the components of the current version of the product; and
the unique identifiers associated with the components; and
posting the manifest to a location where it can be distributed to at least one recipient system associated with the local version of the product.

17. The computerized method of claim 16, wherein the manifest also includes a time-related indicator which conveys a length of time for which the manifest is valid.

18. One or more machine-readable media containing machine-readable instructions for implementing the computerized method of claim 16.

19. One or more computing devices, comprising:
one or more processors; and
memory to store computer-executable instructions that, when executed by the one or more processors, perform the computerized method of claim 16.

20. A system for modifying a product, comprising:
at least one source of a current version of the product;
a manifest-generating system configured to:
receive information regarding the current version of the product from said at least one source; and
generate a manifest, the manifest identifying a list of components of the current version of the product;
a distribution system configured to disseminate the manifest; and
at least one recipient system having a local version of the product associated therewith, said at least one recipient system configured to:
receive the manifest from the distribution system; and
compare the manifest against the local version of the product to identify a manner in which the local version is to be modified.
